(19) United States
(12) Patent Application Publication
(10) Pub. No.: US 2026/0038104 A1
(43) Pub. Date: Feb. 5, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: DAISUKE SATO, Kanagawa (JP)

(21) Appl. No.: 19/359,038

(22) Filed: Oct. 15, 2025

Related U.S. Application Data
(63) Continuation of application No. PCT/JP2024/014981, filed on Apr. 15, 2024.

(30) Foreign Application Priority Data
Apr. 21, 2023 (JP) 2023-070337

(51) Int. Cl. G06T 7/00

(52) U.S. Cl. CPC G06T 7/0002; G06T 2207/30184

(57) ABSTRACT

An information processing apparatus comprising: an obtaining unit configured to acquire detection information about a first detection process that is a deformation detection process performed on an input image; and an output unit configured to output a type of a second detection process that is a deformation detection process of a type different from that of the first detection process, based on the detection information obtained by the obtaining unit.

### CROSS-REFERENCE TO RELATED APPLICATIONS

This application is a continuation of International Patent Application No. PCT/JP2024/014981, which was filed on April 15, 2024 and which claims priority to Japanese Patent Application No. 2023-070337, which was filed on April 21, 2023, both of which are hereby incorporated by reference herein in their entireties.

### BACKGROUND

### Field of the Technology

The present disclosure relates to an information processing apparatus, an information processing method for image processing, and a storage medium.

### Description of the Related Art

In inspections of wall surfaces of structures, such as bridges, image inspections are conducted in which deformations are automatically detected through image processing and/or inference processing based on captured images of an inspection target. Services have been developed that allow users to access image inspections via a network from terminals that the users use.

Japanese Patent No. 6944506 describes a method for detecting deformations in captured images of infrastructure structures through image processing based on a plurality of thresholds, numerical ranges, and other configuration parameters.

In detecting deformations of infrastructure structures, there is a need to detect various types of deformations, such as water leakage and free lime, in addition to cracks. However, increasing the number of types of deformations to be detected leads to longer processing times. Moreover, in the case of cloud services based on usage-based billing, this also results in higher service usage fees for users. Therefore, users tend to narrow down the types of deformations to be detected in deformation detection processes. This may result in overlooking deformations that should ideally have been detected and repaired from a safety perspective. Thus, for infrastructure structures, it is demanded to appropriately select the types of deformation detection processes from a safety perspective.

### SUMMARY

According to an aspect of the present disclosure, an information processing apparatus includes an obtaining unit configured to obtain detection information relating to a first detection process performed on an input image, the first detection process being for detecting a deformation, and an output unit configured to output a type of a second detection process different in type from the first detection process, based on the detection information obtained by the obtaining unit, the second detection process being for detecting a deformation.

Features of the present disclosure will become apparent from the following description of embodiments with reference to the attached drawings.

### BRIEF DESCRIPTION OF THE DRAWINGS

FIG. 1 is a block diagram illustrating a hardware configuration of an information processing apparatus according to a first embodiment of the present disclosure.

FIG. 2 is a block diagram illustrating a system configuration of an information processing apparatus according to the first embodiment of the present disclosure.

FIG. 3 is a flowchart illustrating a detection process according to the first embodiment of the present disclosure.

FIG. 4 illustrates an example of a detection process execution screen in the first embodiment of the present disclosure.

FIG. 5 illustrates examples of crack detection results in the first embodiment of the present disclosure.

FIG. 6 illustrates an example of combinations of region types of detection targets and proposed detection processes according to the first embodiment of the present disclosure.

FIG. 7 illustrates an example of combinations of detection process results and proposed detection processes according to the first embodiment of the present disclosure.

FIG. 8 illustrates an example of a detection process result confirmation screen according to the first embodiment of the present disclosure.

FIG. 9 illustrates an example of an additional detection process execution screen according to the first embodiment of the present disclosure.

FIG. 10 illustrates an example of a detection process result confirmation screen including an additional detection process result according to the first embodiment of the present disclosure.

FIG. 11 is a flowchart illustrating a detection process in a second embodiment according to the present disclosure.

FIG. 12 is an example of an additional detection process execution screen in the second embodiment of the present disclosure.

FIG. 13 is an example of a detection process result confirmation screen including an additional detection process result according to the second embodiment of the present disclosure.

### DESCRIPTION OF THE EMBODIMENTS

The present disclosure will now be described in detail based on embodiments with reference to the accompanying drawings. The configurations illustrated in the following embodiments are merely examples, and the present disclosure is not limited to the illustrated configurations.

### <First Embodiment>

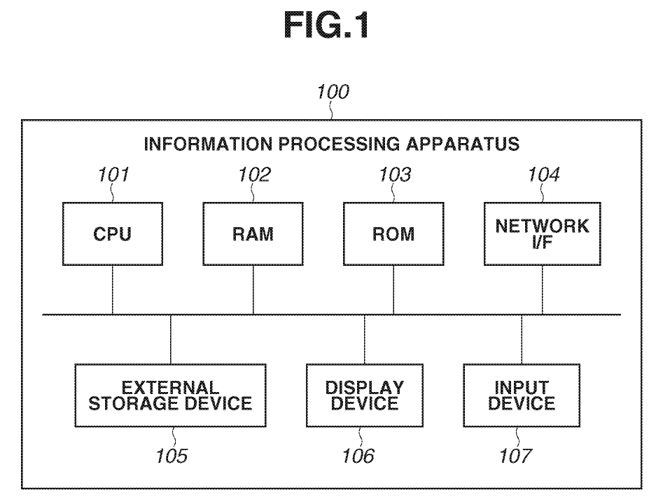

An example of a hardware configuration of an information processing apparatus according to the present embodiment is described with reference to a block diagram in FIG. 1. An information processing apparatus 100 includes a central processing unit (CPU) 101, a random access memory (RAM) 102, and read only memory (ROM) 103. The information processing apparatus 100 further includes a network interface 104, an external storage device 105, a display device 106, and an input device 107.

The CPU 101 controls the operation of each unit of the information processing apparatus 100, and also serves as a main component for executing various processes described below as processes that are performed by the information processing apparatus 100. The RAM 102 is a memory that temporarily stores data and control information, and serves as a working area used when the CPU 101 executes various types of processes. The ROM 103 stores fixed operation parameters, operation programs, and other types of data for the information processing apparatus 100. The network interface 104 provides functionality for connecting to a network to perform communication. The information processing apparatus 100 can transmit and receive data to and from external apparatuses via the network interface 104. The external storage device 105 stores data, and includes an interface that receives Input/Output (I/O) commands for reading and writing data. The external storage device 105 may be a hard disk drive (HDD), a solid state drive (SSD), an optical disk drive, a semiconductor storage device, or another type of storage device. The external storage device 105 stores a computer program and data for causing the CPU 101 to execute processes to be described below as processes that are performed by the information processing apparatus 100. The display device 106 is, for example, a liquid crystal display (LCD) or the like, and displays information necessary for the user. The input device 107 is, for example, a keyboard, a mouse, a touch panel, or the like, and receives necessary input from the user.

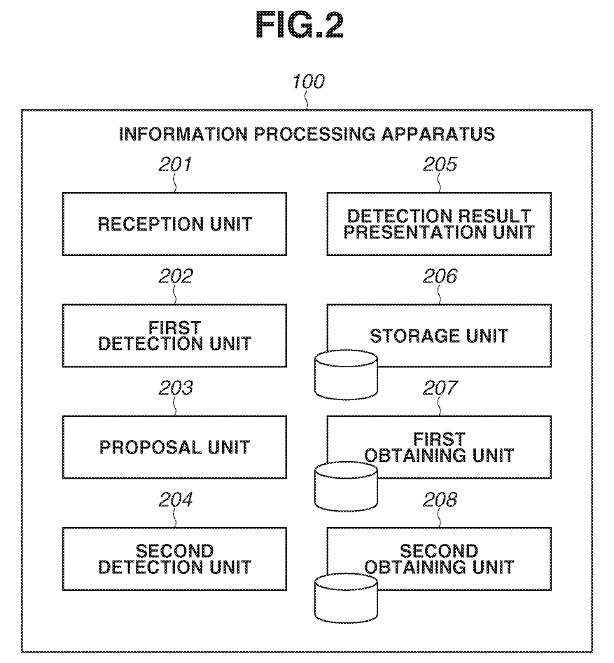

Next, an example of a functional configuration of the information processing apparatus 100 according to the present embodiment will be described with reference to a block diagram in FIG. 2. The information processing apparatus 100 includes a reception unit 201, a first detection unit 202, a proposal unit 203, a second detection unit 204, a detection result presentation unit 205, a storage unit 206, a first obtaining unit 207, and a second obtaining unit 208.

The reception unit 201 receives, from the user, a deformation detection request which requests detection of deformations on a captured image of an infrastructure structure as well as a request for presentation of a result of a deformation detection process. The first detection unit 202 executes a first detection process in response to a deformation detection request transmitted from the user. The proposal unit 203 proposes a second detection process to the user based on a target image corresponding to a deformation detection request and a result of the process performed by the first detection unit 202. The second detection unit 204 executes the second detection process. The detection result presentation unit 205 presents a first detection process result and a second detection process result in response to a detection result presentation request from the user. The storage unit 206 stores a result indicating whether the user has accepted the second detection process that the proposal unit 203 has proposed to the user. The first obtaining unit 207 stores region type combination information, and obtains a deformation detection process that is highly relevant to the target image corresponding to the deformation detection request when the second detection process is proposed. The second obtaining unit 208 stores detection result combination information, and obtains a deformation detection process that is highly relevant to a first detection result when the second detection process is proposed.

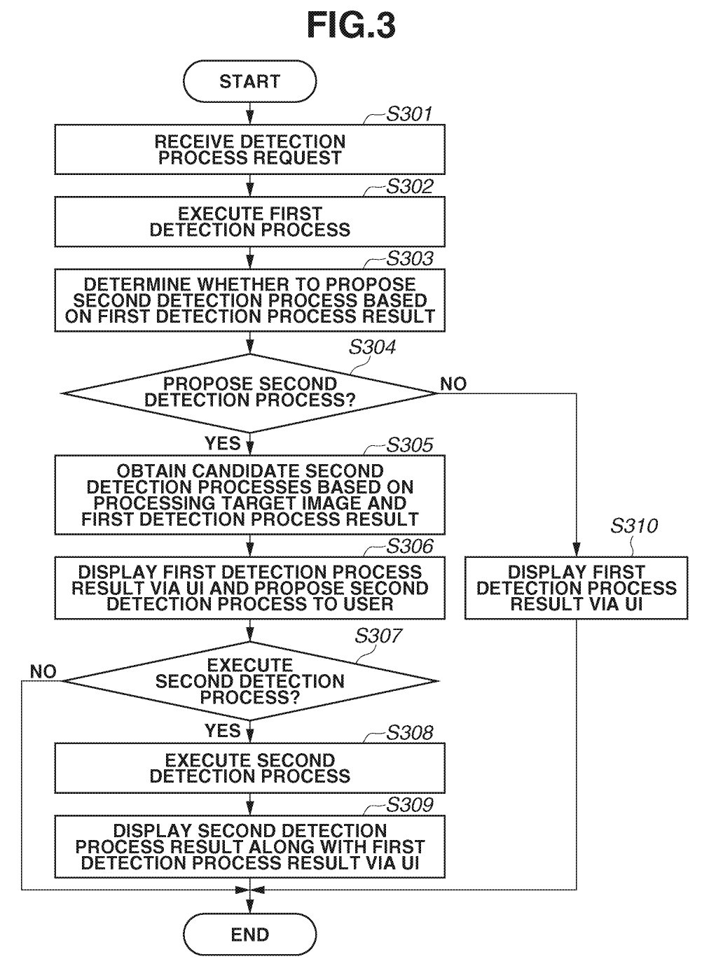

Next, the operation of the information processing apparatus 100 according to the present embodiment will be described with reference to the flowchart in FIG. 3. Initially, in step S301, the reception unit 201 receives a request from the user to perform a deformation detection process on a captured image of an infrastructure structure.

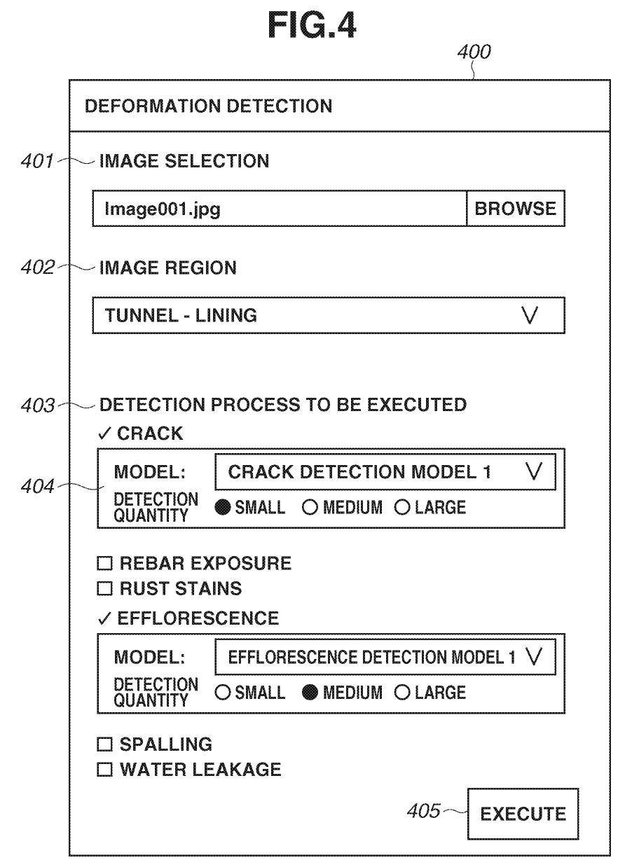

FIG. 4 illustrates an example of a user interface (UI) for receiving a deformation detection request. A deformation detection screen 400 receives a request for deformation detection. A form 401 is used to designate an image file obtained by imaging an infrastructure structure to be subjected to deformation detection. A form 402 is used to designate the type of infrastructure structure captured in the image file to be detected. A form 403 is used to select the type of detection process to be executed. A form 404 is used to select processing parameters for the detection process to be executed. A button 405 is used to execute a detection process based on information input to the deformation detection screen.

Next, in step S302, a first detection process is executed based on the request received in step S301.

Next, in step S303, it is determined whether to propose a second detection process based on a result of the first detection process executed in step S302.

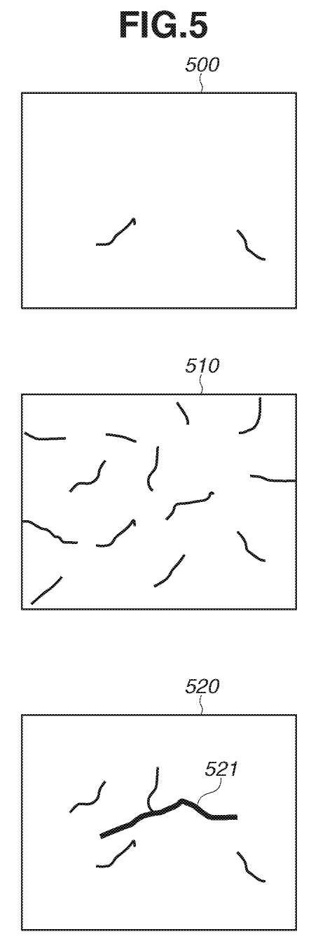

FIG. 5 illustrates examples of results of first detection processes through which cracks have been detected. Display results 500, 510, and 520 present representations, on a screen, of detected cracks.

In the display result 500, the number of detected cracks is low and the crack widths are narrow. In the case of such a result, it is unlikely that the target structure has significantly degraded, and executing other detection processes will likely fail to detect additional deformation or will detect only minor deformation. Thus, it is determined not to propose the second detection process.

In the display result 510, many detected cracks are present in the image. In the case of such a result, the target structure is likely to have significantly degraded, and executing other detection processes will likely detect additional deformation. Thus, it is determined to propose the second detection process.

In the display result 520, while the number of detected cracks is low, a wide crack 521 is detected. In the case of such a result, damage is likely to be present around the crack 521, and executing other detection processes is likely to detect additional deformation. Thus, it is determined to propose the second detection process.

In the present embodiment, whether to propose the second detection process is determined based on the number of cracks and the widths of the cracks, but the determination may alternatively be based on other features, such as the lengths of the cracks.

In the present embodiment, as an example, whether to propose the second detection process is determined based on a result of a detection process for cracks. Alternatively, whether to propose the second detection process may be determined based on a result of detection for other deformations, such as water leakage and free lime.

In step S304, if it is determined to propose the second detection process (YES, in step S304), the processing proceeds to step S305. Otherwise (NO, in step S304), the processing proceeds to step S310.

In step S305, a candidate or candidates for the second detection process are obtained based on the target image of the detection process and the result of the first detection process. In the present embodiment, the candidate(s) for the second detection process is/are obtained based on combination information previously stored in the first obtaining unit 207 and the second obtaining unit 208.

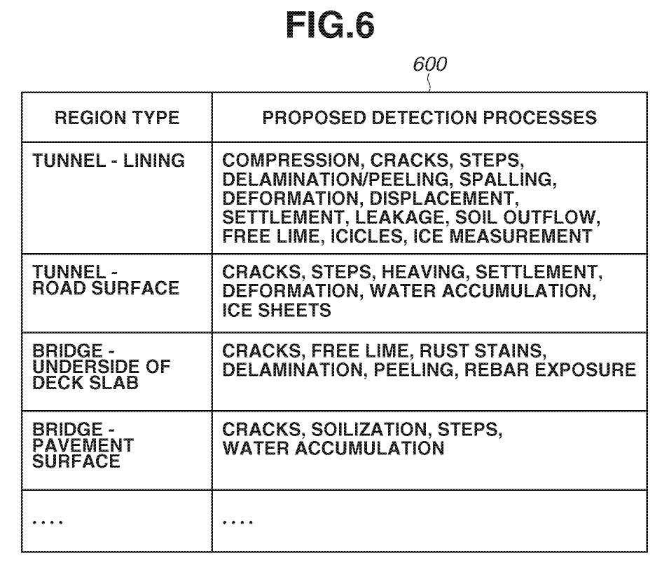

FIG. 6 illustrates an example of combinations of types of regions in images and proposed detection processes. In the inspection of an infrastructure structure, the types of deformations that are likely to occur and the types of deformations requiring attention vary depending on the type of the infrastructure structure. For example, in tunnel lining concrete, various deformations, such as deformations and cracks due to earth pressure, water leakage caused by rainwater or groundwater seeping through cracks, and free lime are likely to occur. On the basis of such knowledge, combinations of region types and proposed detection processes are stored in the first obtaining unit 207. In a case where a region in the target image is classified as "Tunnel – Lining", detecting the corresponding deformations is proposed as the second deformation detection, thus enabling effective detection of deformations.

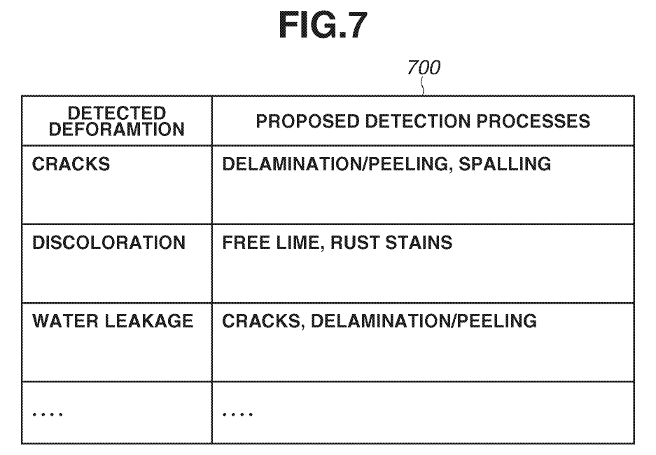

FIG. 7 illustrates an example of combinations of deformations detected in a first detection process and proposed detection processes. In a case where a certain deformation is detected, another deformation is likely to exist in its vicinity. For example, degradation of the wall surface of an inspection target may result in cracks on the wall surface. If such cracks occur in a continuous pattern, the concrete near the surface and the inner concrete may lose their integrity, potentially resulting in delamination.

If delamination further progresses, the surface may peel off, which may result in spalling. Combinations of detected deformations and proposed detection processes based on such knowledge are stored in the second obtaining unit 208.

In a case where a crack is found in the first detection process, proposing detection of the corresponding deformation(s) as the second detection process enables effective deformation detection. In addition, candidate(s) for a type of the second detection process, obtained based on a combination of a region type and a type(s) of proposed detection process and a combination of deformation(s) detected in the first detection process and a type(s) of a proposed detection process, is/are proposed to the user. This enables the user to select and execute a further effective detection process.

In a case where there are many candidates for the second detection process, proposing all the candidates may cause confusion for the user. In such cases, a method of selecting some of the candidates for the second detection process and proposing the selected candidates may be considered. As a selection criterion, the user's operation history may be referenced, and detection processes that the user has not used or has used infrequently may be selected.

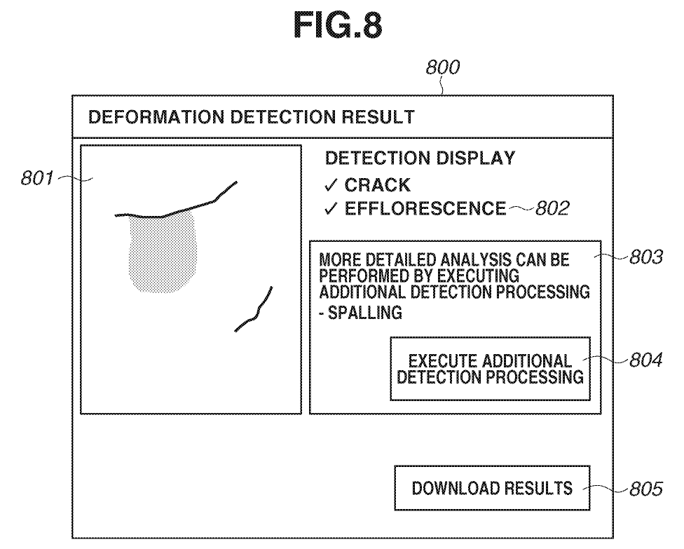

In step S306, the result of the first detection process is presented to the user, and the second detection process is proposed. FIG. 8 illustrates an example of a UI for presenting a result of a first detection process. A screen 800 presents a result of deformation detection to the user. A display result 801 presents deformations detected in the first detection process, which are rendered on the screen. A field 802 indicates the types of deformations detected in the first detection process. A field 803 is used to propose the second detection process to the user. A button 804 is used to transition to a second detection process execution screen. A button 805 is used to download the result of the first detection process as an image or coordinate information.

In step S310, the result of the first detection process is presented to the user.

In step S307, if the user selects execution of the second detection process (YES, in step S307), the processing proceeds to step S308. If the user does not select execution of the second detection process (NO, in step S307), the processing ends.

Next, in step S308, in response to receiving a second deformation detection process request from the user, a second detection process is executed.

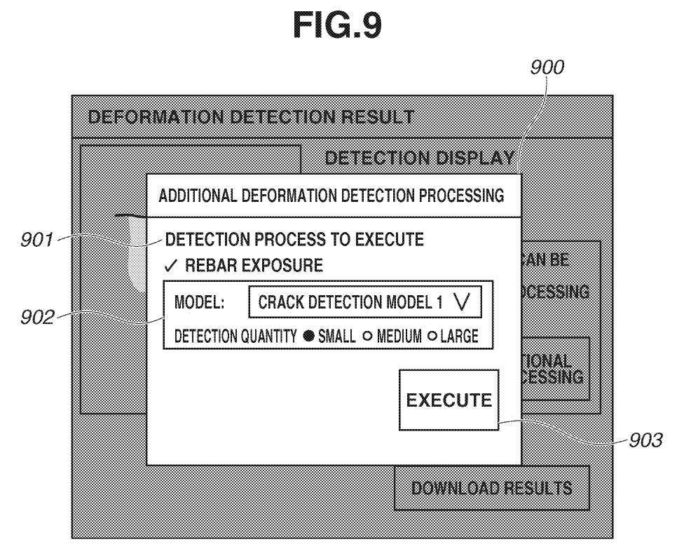

FIG. 9 illustrates an example of a UI for receiving a second deformation detection process request. A window 900 receives a request for deformation detection. A form 901 is used to select the type of detection process to be executed. A form 902 is used to select processing parameters for the detection process to be executed. A button 903 is used to execute the detection process based on information input to the deformation detection screen.

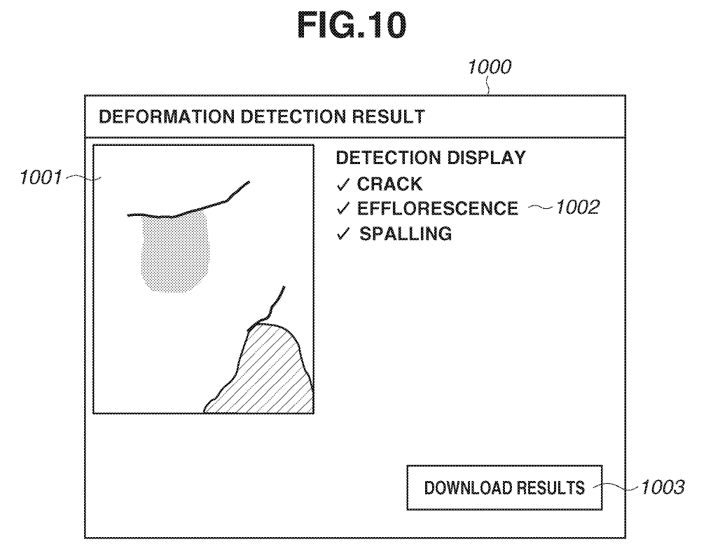

Next, in step S309, the result of the first detection process and the result of the second detection process are presented to the user. FIG. 10 illustrates an example of a UI for presenting the first and second detection results to the user. A screen 1000 presents the deformation detection results to the user. A display result 1001 is a representation, on the screen, of deformations detected in the first and second detection processes. A field 1002 indicates the type of deformations detected in the first and second detection processes. A button 1003 is used to download the results of the first and second detection processes as an image or coordinate information.

Using only the first detection process may result in insufficient detection of deformation types that should be detected from a safety perspective, potentially hindering necessary actions such as repairs to maintain safety. As described above, the information processing apparatus 100 in the present disclosure proposes type(s) of the second detection process to be performed from a safety perspective to the user, based on a target image on which the user has requested deformation detection process and a result of the first detection process executed on the target image. If the user selects execution of the second detection process, the result of the second detection process is presented to the user along with the result of the first detection process. This enables the user to perform necessary detection processes while minimizing processing time and cost. For example, in a deformation detection service for structures where separate fees are charged for each type of deformation to be detected (such as cracks, water leakage, or spalling), the user can execute only necessary detection processes without performing all the detection processes.

In the present embodiment, a system that detects deformations in an image of an infrastructure structure, which serves as an image to be processed, has been described as an example. However, the present disclosure is not limited to this, and it can be applied to any processing in which a plurality of detection processes are executed on a target image. For example, the present disclosure may be applicable to detection of scratches or stains on agricultural produce, detection of lesions in medical images, or the like.

### <Second Embodiment>

In the first embodiment, a method is proposed in which execution of the second detection process is proposed to the user based on a target image and a result of execution of the first detection process on the target image, thus enabling the user to execute necessary detection processes while minimizing increases in processing time and cost. Here, when a detection process that the user has never used before or has used only a few times is proposed to the user, they may be unable to know what kind of results can be obtained by executing the proposed detection process. By presenting, as a sample, the result of executing the proposed detection process on a partial region of a target image to a user who is unsure whether to execute the proposed detection process, the user can use the sample as a basis for determining whether to execute the proposed detection process. Thus, in a second embodiment, a method is described in which the second detection process is executed on a partial region of a target image and the detection result is presented to the user. In the present embodiment, examples of the hardware configuration and functional configuration are similar to those in the first embodiment, and thus the description thereof will be omitted.

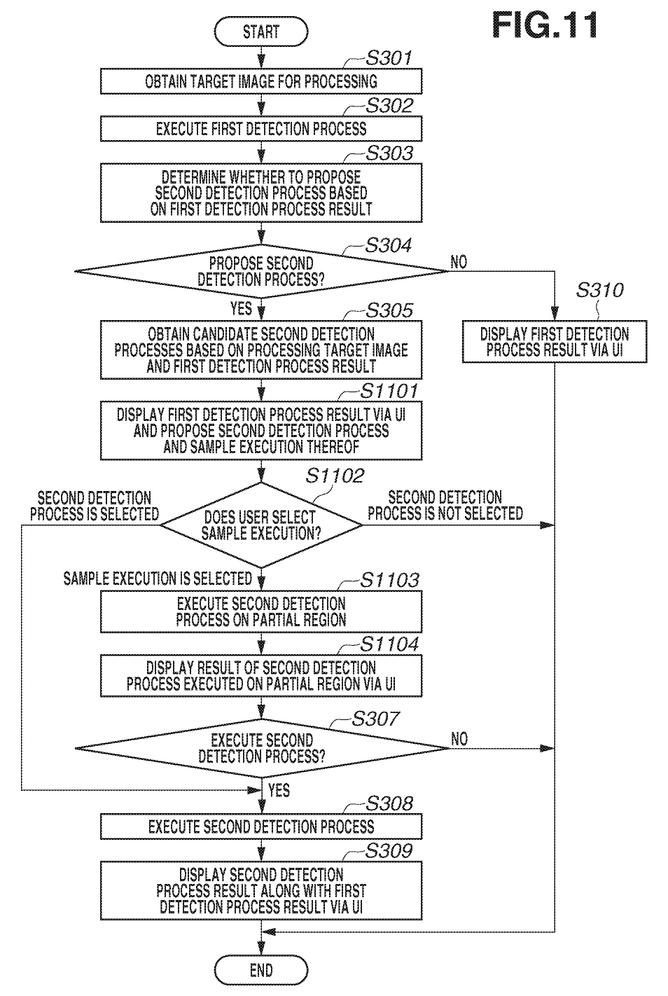

The operation of the information processing apparatus 100 according to the present embodiment will be described with reference to the flowchart of FIG. 11. Descriptions of operations similar to those described in the first embodiment will be omitted.

In step S1101, the result of a first detection process is presented to the user, and a second detection process and sample execution of the second detection process are proposed.

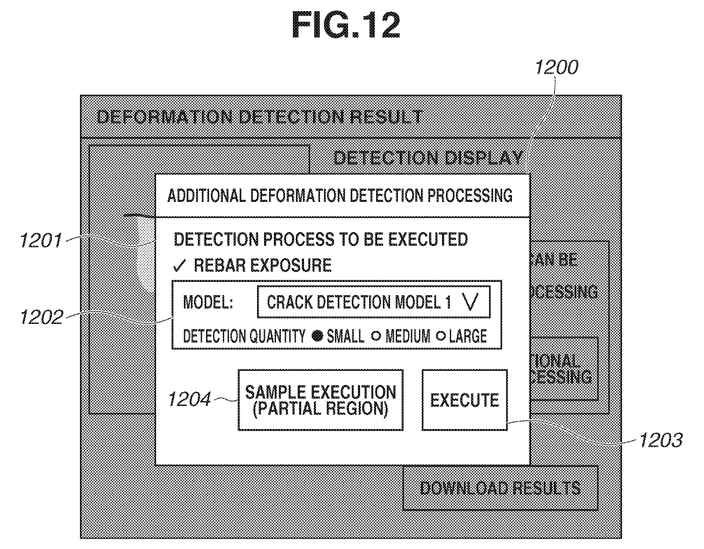

FIG. 12 illustrates an example of a UI for receiving a second deformation detection process request and a request for sample execution of a second detection process. A window 1200 is used for receiving a deformation detection process request and a request for sample execution. A form 1201 is used for selecting the type of detection process to be executed. A form 1202 is used for selecting processing parameters for the detection process to be executed. A button 1203 is used for executing the detection process based on the information input to the deformation detection screen. A button 1204 is used for performing sample execution of the detection process based on the information input to the deformation detection screen.

In step S1102, if the user selects sample execution of the second detection process ("Sample Execution is Selected", in step S1102), the processing proceeds to step S1103. If the user selects the execution of the second detection process ("Second Detection Process is Selected", in step S1102), the processing proceeds to step S308. If neither is selected ("Second Detection Process is Not Selected" in step S1102), the processing ends.

Next, in step S1103, the second detection process is executed on a partial region. In this case, it is suitable to select, as a partial region, a region where a greater number of deformations are likely to be detected when the detection process is executed. Specifically, a method may be employed in which a region where a certain level of deformation has been found in the first detection process, and a region where deformations highly relevant to the second detection process have been found, are adopted. For example, in portions where many cracks are present in an image, degradation of the structure is expected, and executing the detection process on such portions may lead to the detection of other types of deformations. In addition, in portions surrounding detected wall surface spalling, there is a high possibility that rebar exposure can also be detected. In this manner, presenting, as a sample, a region where deformation has been detected to the user can prompt the user to execute the second detection process.

Next, in step S1104, the result of the first detection process and the result of the second detection process that has been performed on the partial region are presented to the user.

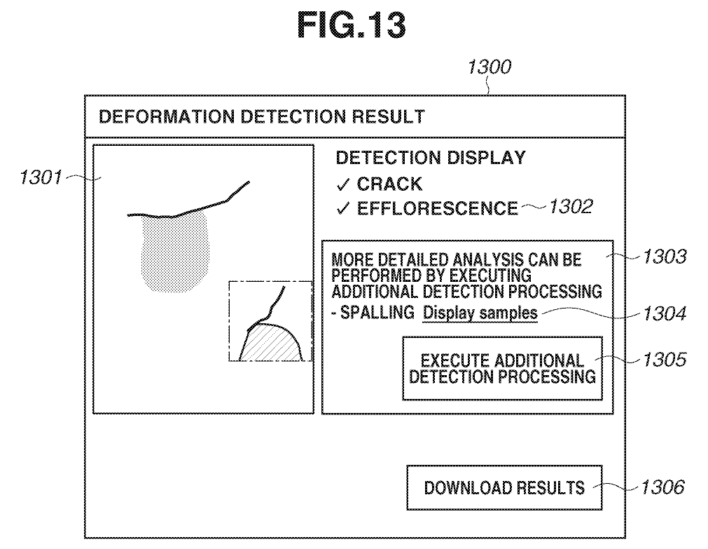

FIG. 13 illustrates an example of a UI that presents to the user a result of the first detection process and a result of the second detection process that has been performed on the partial region. A screen 1300 presents a deformation detection result to the user. A display result 1301 is a representation, on the screen, of deformations detected through the first detection process and the second detection process that has been performed on the partial region. A field 1302 indicates the types of the deformations detected in the first detection process. A field 1303 is used to propose the second detection process to the user. A button 1304 is used to display a result of the second detection process executed, as a sample, on a partial region on the display result 1301. A button 1305 is used to transition to a second detection process execution screen. A button 1306 is used to download the first detection process result as an image or coordinate information.

As described above, according to the information processing apparatus 100 of the present disclosure, the second detection process is executed on a partial region of a target image, and a result thereof is presented to the user as a sample, so that the user can use the sample as a basis for determining whether to execute the proposed detection process.

### <Third Embodiment>

In the first and second embodiments, the second detection process is presented to the user, and the second detection process is executed in a case where the user selects execution of the second detection process. The present disclosure is not limited to this, and the second detection process may be executed at the stage of obtaining a candidate(s) for the second detection process, and in a case where the user selects the execution of the second detection process, a result of the process executed in advance may be presented. This eliminates the need for the user to wait until the processing result is presented after selection of execution of the second detection process, and enables the user to more easily try the proposed detection process.

According to the present disclosure providing the above-described configurations, an appropriate type of detection process can be output.

### <Other Embodiments>

Although examples of the embodiments described above have been described in detail, the present disclosure may be implemented in various forms, such as a system, apparatus, method, program, or recording medium (storage medium). Specifically, the present disclosure may be applied to a system including a plurality of devices (e.g., a host computer, interface device, imaging apparatus, web application, etc.), or to an apparatus including a single device.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. An information processing apparatus comprising:
one or more memories storing instructions, and
one or more processors that execute the instructions to:
obtain detection information relating to a first detection process performed on an input image, the first detection process being for detecting a deformation; and
output a type of a second detection process different in type from the first detection process, based on the obtained detection information obtained, the second detection process being for detecting a deformation.

2. The information processing apparatus according to claim 1, wherein the detection information includes at least one of a type of an object appearing in the input image and a result of the first detection process.

3. The information processing apparatus according to claim 1,
wherein the detection information includes a degree of the deformation, and
wherein the one or more processors are configured to determine whether to output a type of the second detection process based on the obtained degree of the deformation.

4. The information processing apparatus according to claim 1, wherein the one or more processors are configured to determine a type of the second detection process based on the obtained detection information.

5. The information processing apparatus according to claim 1,
wherein the one or more processors are configured to output a type of the second detection process to a display device, and
wherein the display device displays the type of the second detection process.

6. The information processing apparatus according to claim 1,
wherein the one or more processors are configured to obtain information about a combination of a type of the object appearing in the input image and a type of the second detection process from a storage unit that stores combinations of types of objects appearing in images and types of the second detection process, and
wherein the one or more processors are configured to output the type of the second detection process based on the obtained information about the combination.

7. The information processing apparatus according to claim 2,
wherein the one or more processors are configured to obtain information about a combination of a result of the first detection process and a type of the second detection process from a storage unit that stores combinations of results of the first detection process and types of the second detection process, and
wherein the one or more processors are configured to output a type of the second detection process based on the obtained information about the combination.

8. The information processing apparatus according to claim 1,
wherein the one or more processors are configured to obtain history information regarding detection processes from a storage unit that stores history of detection processes previously executed, and
wherein the one or more processors are configured to output a type of the second detection process based on the obtained history information.

9. The information processing apparatus according to claim 8, wherein the one or more processors are configured to output a priority order of types of the second detection process based on the obtained history information regarding the detection processes.

10. The information processing apparatus according to claim 2,
wherein the one or more processors are configured to output a plurality of types of the second detection process,
wherein the one or more processors are configured to obtain, from among the plurality of types of the second detection process, a type of the second detection process selected by a user, and
wherein the one or more processors are configured to execute the second detection process of the obtained type.

11. The information processing apparatus according to claim 10,
wherein the one or more processors are configured to execute the second detection process on a partial region of the input image, and
wherein the one or more processors are configured to output a result of the executed second detection process.

12. The information processing apparatus according to claim 11, wherein the one or more processors are configured to determine the partial region based on a result of the first detection process.

13. The information processing apparatus according to claim 10,
wherein the one or more processors are configured to execute a plurality of types of the second detection process before outputting the plurality of types of the second detection process, and
wherein the one or more processors are configured to output the plurality of types of the second detection process together with detection results of the plurality of types of the second detection process.

14. The information processing apparatus according to claim 1, wherein the first detection process and the second detection process are processes for detecting deformation of a structure.

15. An information processing method comprising:
obtaining detection information relating to a first detection process performed on an input image, the first detection process being for detecting a deformation; and
outputting a type of a second detection process different in type from the first detection process, based on the obtained detection information, the second detection process being for detecting a deformation.

16. A non-transitory computer-readable storage medium storing a computer program for causing a computer to execute an information processing method comprising:
obtaining detection information relating to a first detection process performed on an input image, the first detection process being for detecting a deformation; and
outputting a type of a second detection process different in type from the first detection process, based on the obtained detection information, the second detection process being for detecting a deformation.
